(19) United States
(12) Patent Application Publication
(10) Pub. No.: US 2026/0016088 A1
(43) Pub. Date: Jan. 15, 2026

(54) SEALING RING ASSEMBLY STRUCTURE AND ELECTRONIC DEVICE

(71) Applicant: AAC ACOUSTIC TECHNOLOGIES (SHENZHEN) CO., LTD., Shenzhen (CN)

(72) Inventors: Dexing Wang, Shenzhen (CN); Jinyu Zhang, Shenzhen (CN); Yuanhua Tang, Shenzhen (CN); Shaoping Huang, Shenzhen (CN)

(21) Appl. No.: 19/006,244

(22) Filed: Dec. 31, 2024

Related U.S. Application Data
(63) Continuation of application No. PCT/CN2024/105150, filed on Jul. 12, 2024.

(51) Int. Cl. F16J 15/10

(52) U.S. Cl. CPC F16J 15/10

(57) ABSTRACT

Provided is a sealing ring assembly structure and electronic device. The sealing ring assembly structure comprises an assembly body having a main body and a limiting convex ring protruding therefrom, and a sealing ring. The limiting convex ring and the main body jointly enclose to form a limiting groove. The main body has a first through hole communicating with the limiting groove. The sealing ring is accommodated in the limiting groove, and comprises a ring body and an adhesive layer through which the ring body is adhered and fixed to the limiting groove. The ring body abuts against the groove wall of the limiting groove. The sealing ring has a second through hole penetrating the ring body and the adhesive layer and coaxially arranged with the first through hole. The sealing ring assembly structure is easy and accurate to assemble, the assembling efficiency and the product yield are improved.

### TECHNICAL FIELD

The present disclosure relates to the technical field of sealing rings, and in particular to a sealing ring assembly structure and an electronic device.

### BACKGROUND

In the related art, an assembly body is provided with an assembly hole. In order to prevent external dust and foreign substance from intruding into the assembly hole, a sealing ring coaxially arranged with the assembly hole needs to be adhered to the surface of the assembly body to protect the assembly hole. However, the existing sealing rings are directly adhered to the planar surface of the assembly body. During assembly, it is difficult to accurately adhere the sealing rings to the assembly body, which is prone to misalignment, which not only affects the sealing effect, but also may block the assembly holes, thereby seriously affecting the product yield.

Therefore, it is necessary to provide a sealing ring assembly structure and an electronic device that can be easily assembled.

### SUMMARY

An objective of the present disclosure is to provide a sealing ring assembly structure and an electronic device, to solve the technical problems in the related art that a sealing ring is difficult to be accurately assembled.

The technical solution of the present disclosure is as follows:

In a first aspect, the present disclosure provides a sealing ring assembly structure. The sealing ring assembly structure includes an assembly body and a sealing ring. The assembly body includes a main body and a limiting convex ring protruding from the main body. The limiting convex ring and the main body jointly enclose to form a limiting groove. The main body is provided with a first through hole communicating with the limiting groove. The sealing ring is accommodated in the limiting groove and includes a ring body and an adhesive layer fixed to the bottom surface of the ring body. The ring body is adhered and fixed to the groove bottom surface of the limiting groove through the adhesive layer. The side surface of the ring body abuts against the groove wall of the limiting groove. The sealing ring further includes a second through hole penetrating through the ring body and the adhesive layer. The second through hole and the first through hole are coaxially arranged.

As an improvement, along a direction from the groove opening to the groove bottom of the limiting groove, the limiting groove sequentially includes a first groove section and a second groove section. A groove wall of the first groove section is a frustum cone surface. Along the direction from the groove opening to the groove bottom of the limiting groove, a diameter of the first groove section gradually decreases. A groove wall of the second groove section is a cylindrical surface. The side surface of the ring body is a cylindrical surface. The side surface of the ring body abuts against the groove wall of the second groove section.

As an improvement, a wall of the second through hole is a cylindrical surface. In a direction away from the limiting groove, the first through hole sequentially includes a first hole section and a second hole section, the hole wall of the first hole section is a cylindrical surface, the diameter of the first hole section is equal to the diameter of the second through hole, and the hole wall of the second hole section is a frustum cone surface. In the direction away from the limiting groove, the diameter of the second hole section gradually increases.

As an improvement, a top surface of the ring body is exposed from the limiting groove.

As an improvement, the ring body is made of silicone material.

As an improvement, the ring body includes a first fillet surface extending between the side surface of the ring body and the bottom surface of the ring body.

As an improvement, a second fillet surface extending between the groove wall of the limiting groove and the groove bottom surface of the limiting groove is formed on the assembly body, and the second fillet surface abuts against the first fillet surface.

As an improvement, the adhesive layer is a double-sided adhesive.

As an improvement, the assembly body includes a plurality of limiting convex rings, and each of the limiting convex rings and the main body jointly enclose to form one limiting groove. The main body is provided with a plurality of first through holes, and the first through holes and the limiting grooves are arranged in one-to-one correspondence. The sealing ring assembly structure includes a plurality of sealing rings, and the sealing rings and the limiting grooves are arranged in one-to-one correspondence.

In a second aspect, the present disclosure provides an electronic device including any one of the above sealing ring assembly structures.

The present disclosure model has the following beneficial effects. According to the sealing ring assembly structure in the present disclosure, the limiting convex ring and the main body of the assembly body jointly enclose to form the limiting groove, the ring body of the sealing ring is adhered and fixed to the groove bottom surface of the limiting groove through the adhesive layer, and the side surface of the ring body abuts against the groove wall of the limiting groove, so that the second through hole and the first through hole can be effectively aligned and successfully coaxially arranged, so as to effectively prevented the sealing ring from misalignment as well as blocking the first through hole, so that the assemblying is eay and accurate, and the assembly efficiency and the product yield are improved.

### BRIEF DESCRIPTION OF DRAWINGS

FIG. 1is a perspective view of a sealing ring assembly structure according to the present disclosure.

FIG. 2 is an enlarged view of portion A of FIG. 1.

FIG. 3is an exploded view of a sealing ring assembly structure according to the present disclosure.

FIG. 4 is an enlarged view of portion B of FIG. 3.

FIG. 5is a perspective view of a sealing ring assembly structure according to the present disclosure.

FIG. 6 is a partial structural schematic diagram of FIG. 5.

FIG. 7 is an enlarged view of portion C of FIG. 6.

FIG. 8is a schematic structural diagram of a sealing ring in the sealing ring assembly structure according to the present disclosure.

FIG. 9 is D-D sectional view of FIG. 8.

### DESCRIPTION OF EMBODIMENTS

The present disclosure is further described below with reference to accompanied drawings and embodiments.

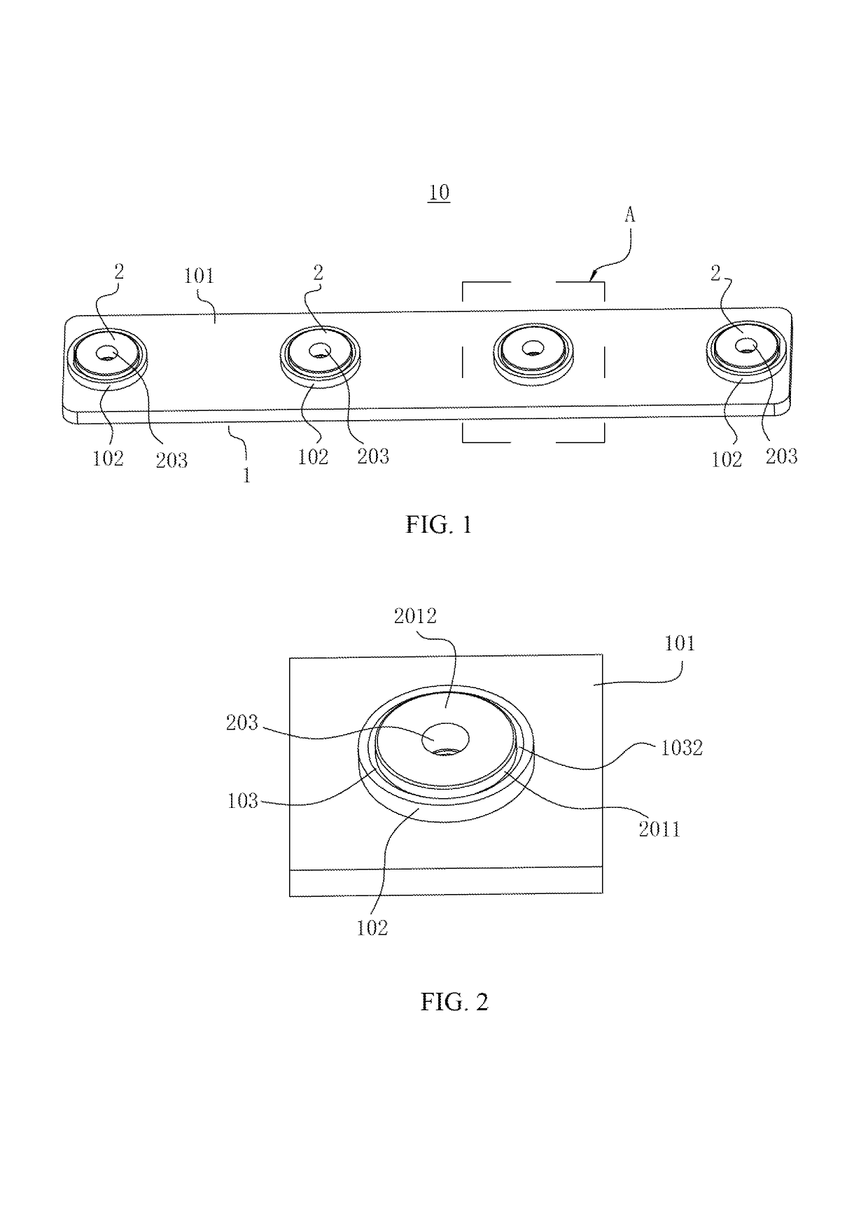

An embodiment of the present disclosure provides a sealing ring assembly structure 10 including an assembly body 1 and a sealing ring 2, as shown in FIG. 1to FIG. 9. The assembling body 1 includes a main body 101 and a limiting convex ring 102 protruding from the main body 101. The limiting convex ring 102 and the main body 101 jointly enclose to form a limiting groove 103. The main body 101 is provided with a first through hole 104, and the first through hole 104 is communicated with the limiting groove 103. The sealing ring 2 is accommodated in the limiting groove 103. The sealing ring 2 includes a ring body 201 and an adhesive layer 202, and the adhesive layer 202 is fixed to a bottom surface of the ring body 201. The ring body 201 is adhered and fixed to the groove bottom surface 1031 of the limiting groove 103 through the adhesive layer 202. When the ring body 201 is fixed in the limiting groove 103, the side surface 2011 of the ring body 201 abuts against the groove wall of the limiting groove 103. The sealing ring 2 further includes a second through hole 203, the second through hole 203 penetrates through the ring body 201 and the adhesive layer 202, and the second through hole 203 and the first through hole 104 are coaxially arranged.

In an embodiment of the present disclosure, the limiting convex ring 102 and the main body 101 of the assembly body 1 jointly enclose to form the limiting groove 103. The ring body 201 of the sealing ring 2 is adhered and fixed to the groove bottom surface 103 1 of the limiting groove 103 through the adhesive layer 202, and the side surface 2011 of the ring body 201 abuts against the groove wall of the limiting groove 103, so that the second through hole 203 and the first through hole 104 can be effectively aligned to accomplish the coaxial arrangement, which can effectively avoid the poor sealing effect or even the failure of sealing due to the misalignment of the sealing ring 2, and effectively avoid the failure of the effective assembly of the assembly body 1 with other environmental components due to the situation that the sealing ring 2 undesirably blocks the first through hole 104. As a result, the assembly is easy and accurate, and the sealing effect, the assembly efficiency and the product yield are improved.

In some embodiments, along the direction from the opening to the groove bottom of the limiting groove 103, the limiting groove 103 sequentially includes a first groove section 1032 and a second groove section 1033, as shown in FIG. 4and FIG. 6. The groove wall of the first groove section 1032 is a frustum cone surface. Moreover, along the direction from the opening to the groove bottom of the limiting groove 103, the diameter of the first groove section 1032 gradually reduces, thereby facilitating installing the sealing ring 2 into the limiting groove 103. The groove wall of the second groove section 1033 is a cylindrical surface. The side surface 2011 of the ring body 201 is a cylindrical surface, and the side surface 2011 of the ring body 201 abuts against the groove wall of the second groove section 1033, thereby ensuring the sealing effect.

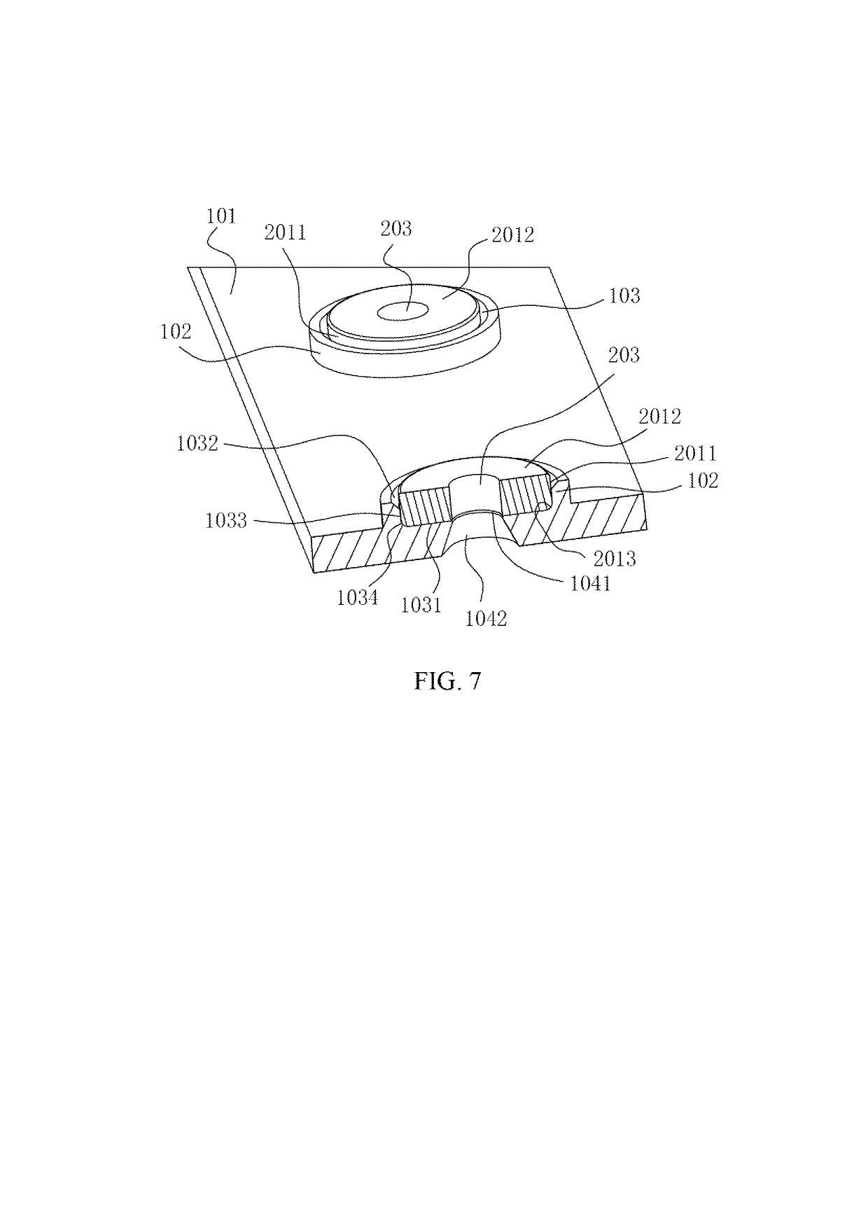

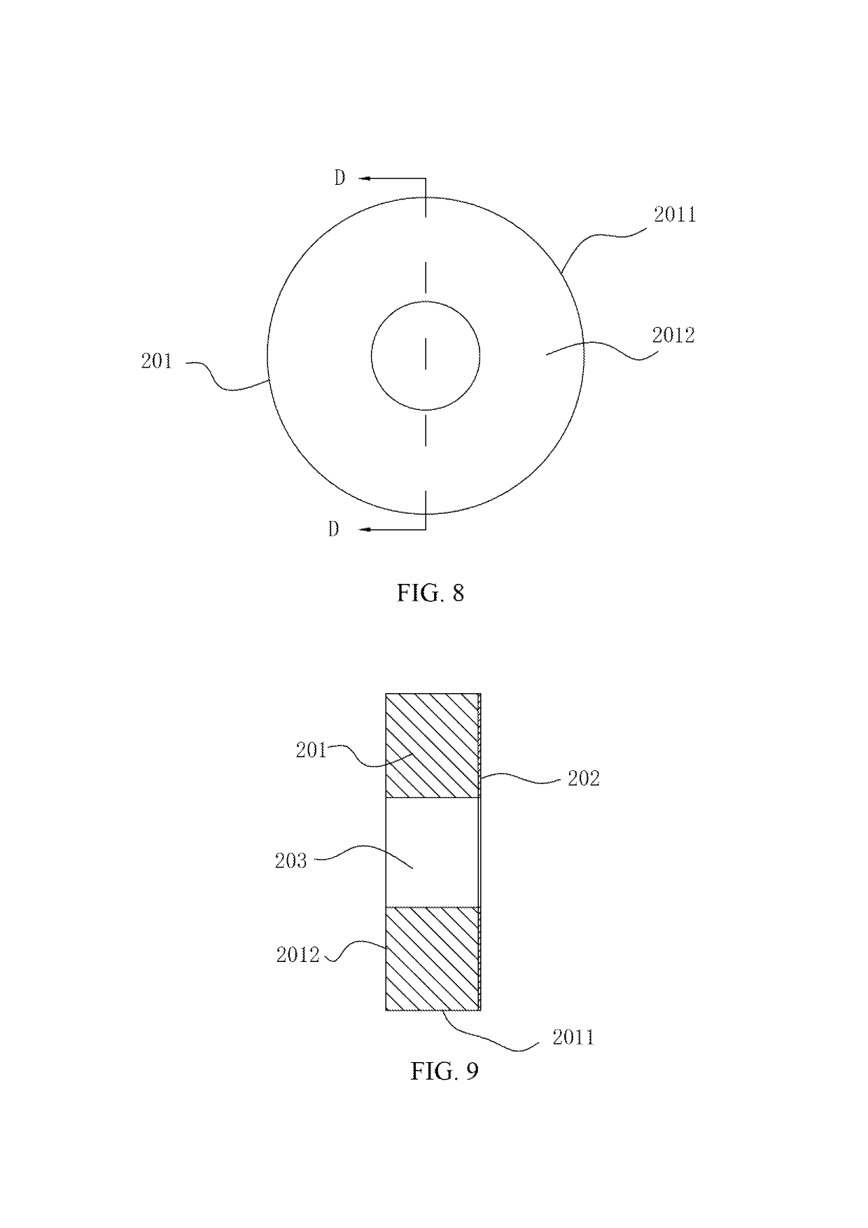

In some embodiments, referring to FIG. 8and FIG. 9, the wall of the second through hole 203 is a cylindrical surface. Referring to FIG. 7, along the direction away from the limiting groove 103, the first through hole 104 sequentially includes a first hole section 1041 and a second hole section 1042. The hole wall of the first hole section 1041 is a cylindrical surface, and the diameter of the first hole section 1041 is equal to the diameter of the second through hole 203, thereby further improving the sealing effect without interfering with the assembly of the assembly body 1 and other environmental components through the first through hole 104. The hole wall of the second hole section 1042 is a frustum cone surface. Along the direction away from the limiting groove 103, a diameter of the second hole section 1042 gradually increases, so as to facilitate assembling the assembly body 1 with other environmental components through the first through hole 104.

In some embodiments, referring to FIG. 2 and FIG. 7, when the ring body 201 is fixed in the limiting groove 103, the top surface 2012 of the ring body 201 is exposed from the limiting groove 103. That is, the height of the sealing ring 2 is greater than the depth of the limiting groove 103, thereby facilitating assembly operation. As a result, the sealing ring 2 can be more firmly fixed in the limiting groove 103.

In some embodiments, the ring body 201 may be made of silicone material, so that assembly is easy, the sealing effect is good, and the service life is long. It should be noted that, in some other embodiments, the ring body 201 may also be made of other materials, which will not be described in detail herein.

In some embodiments, referring to FIG. 7, the ring body 201 includes a first fillet surface 2013 extending between the side surface 2011 of the ring body 201 and the bottom surface of the ring body 201. The ring body 201 has a first fillet surface 2013, which makes it easier to install the sealing ring 2 into the limiting groove 103, and improves the assembly efficiency.

Correspondingly, referring to FIG. 4 and FIG. 7, a second fillet surface 1034 extending between the groove wall of the limiting groove 103 and the groove bottom surface 1031 of the limiting groove 103 is formed on the assembly body 1, and the second fillet surface 1034 abuts against the first fillet surface 2013, so that the sealing ring 2 can be more tightly fitted to the limiting groove 103, and the sealing effect is improved.

In some embodiments, the adhesive layer 202 is double-sided adhesive, which is not only low in cost, convenient to use and easy to assemble, but also can effectively fix the ring body 201 to the assembly body 1. It should be noted that, in other embodiments, the adhesive layer 202 may also be another adhesive, which will not be described in detail herein.

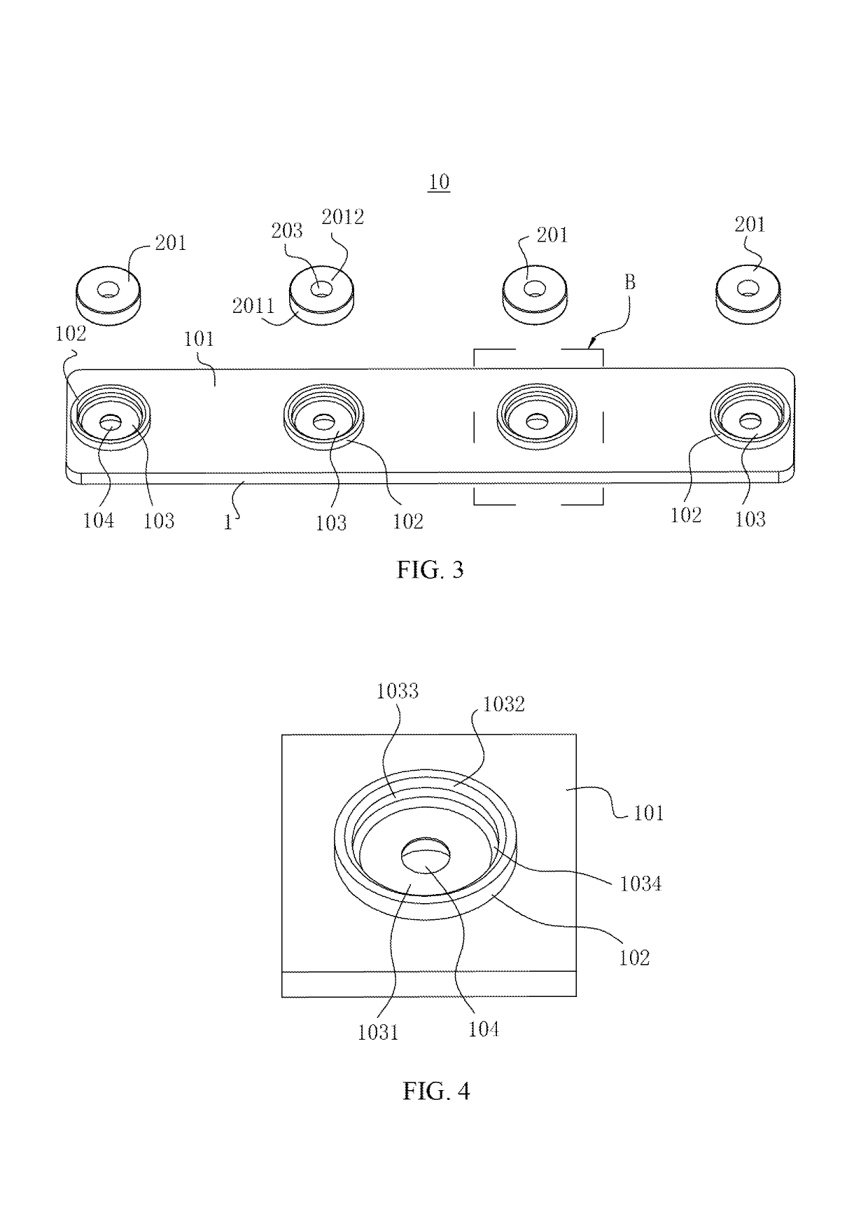

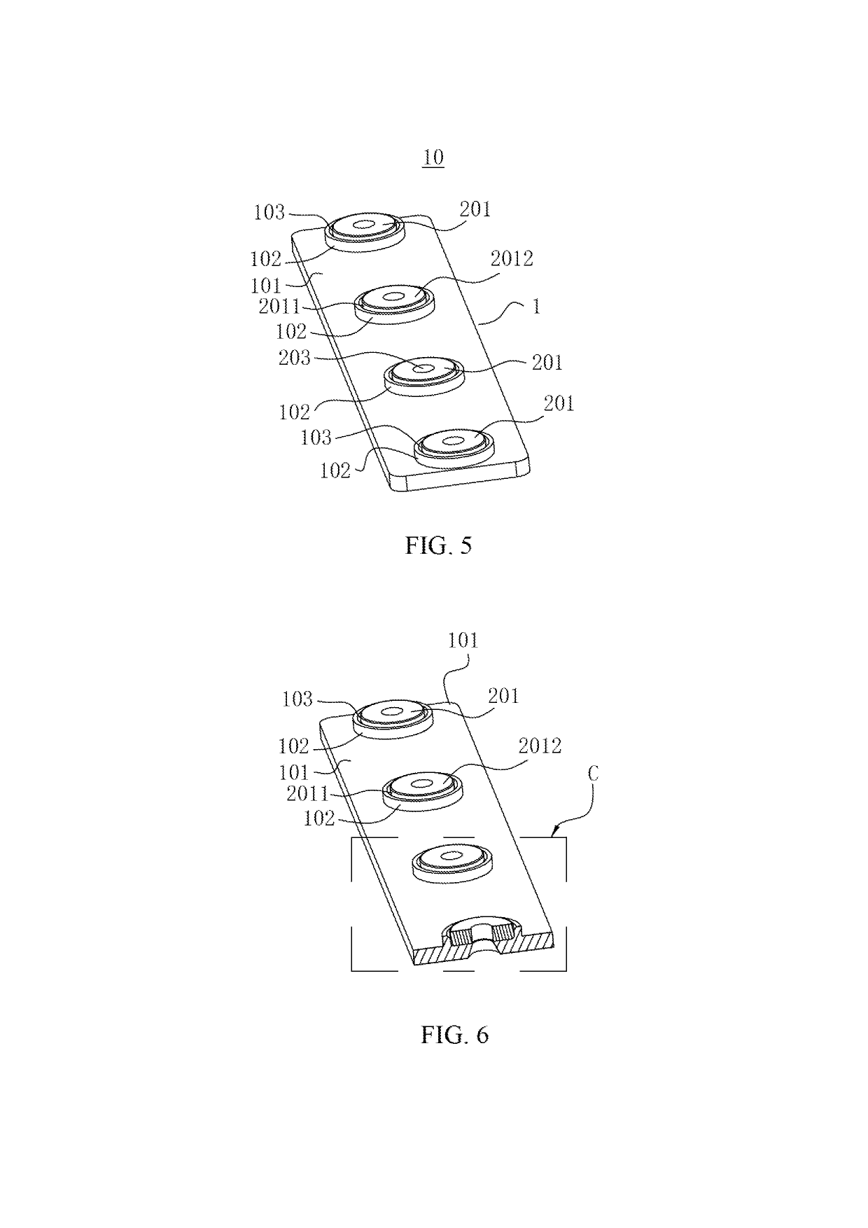

In some embodiments, referring to FIGS. 1, 3 and 5, the assembly body 1 includes a plurality of limiting convex rings 102, and each of the limiting convex rings 102 and the main body 101 jointly enclose to form a limiting groove 103, respectively. That is, the number of the limiting grooves 103 is equal to the number of the limiting convex rings 102. The main body 101 is provided with a plurality of first through holes 104, and the first through holes 104 and the limiting grooves 103 are arranged in one-to-one correspondence. The sealing ring assembly structure 10 includes a plurality of sealing rings 2. The sealing rings 2 and the limiting grooves 103 are arranged in one-to-one correspondence. Each of the sealing rings 2 is installed in the corresponding limiting groove 103. As an example, when the sealing ring 2 is installed to the assembly, an automatic device can be used for automatic assembly, and multiple sealing rings 2 may be assembled at one time, thereby improving production efficiency.

An embodiment of the present disclosure further provides an electronic device, including any one of the above sealing ring assembly structures 10.

The above description just describes implementations of the present disclosure. It should be noted that those skilled in the art can also make improvements without departing from the concept of the present disclosure, which shall all fall within the protection scope of the present disclosure.

What is claimed is:

1. A sealing ring assembly structure, comprising:
an assembly body comprising a main body and a limiting convex ring protruding from the main body, wherein the limiting convex ring and the main body jointly enclose to form a limiting groove, and the main body is provided with a first through hole communicating with the limiting groove; and
a sealing ring accommodated in the limiting groove and comprising a ring body and an adhesive layer fixed to a bottom surface of the ring body, wherein the ring body is adhered and fixed to a groove bottom surface of the limiting groove through the adhesive layer, and a side surface of the ring body abuts against a groove wall of the limiting groove, the sealing ring further comprises a second through hole penetrating through the ring body and the adhesive layer, and the second through hole and the first through hole are coaxially arranged.

2. The sealing ring assembly structure as described in claim 1, wherein along a direction from a groove opening to a groove bottom of the limiting groove, the limiting groove sequentially comprises a first groove section and a second groove section, a groove wall of the first groove section is a frustum cone surface, wherein along the direction from the groove opening to the groove bottom of the limiting groove, a diameter of the first groove section gradually decreases, and a groove wall of the second groove section is a cylindrical surface; and
wherein the side surface of the ring body is a cylindrical surface, and the side surface of the ring body abuts against the groove wall of the second groove section.

3. The sealing ring assembly structure as described in claim 1, wherein a wall of the second through hole is a cylindrical surface; and
wherein along a direction away from the limiting groove, the first through hole sequentially comprises a first hole section and a second hole section, a hole wall of the first hole section is a cylindrical surface, and a diameter of the first hole section is equal to a diameter of the second through hole, a hole wall of the second hole section is a frustum cone surface, and along the direction away from the limiting groove, the diameter of the second hole section gradually increases.

4. The sealing ring assembly structure as described in claim 1, wherein a top surface of the ring body is exposed from the limiting groove.

5. The sealing ring assembly structure as described in claim 1, wherein the ring body is made of silicone material.

6. The sealing ring assembly structure as described in claim 1, wherein the ring body comprises a first fillet surface extending between the side surface of the ring body and the bottom surface of the ring body.

7. The sealing ring assembly structure as described in claim 6, wherein the assembly body is provided with a second fillet surface extending between the groove wall of the limiting groove and the groove bottom surface of the limiting groove, and the second fillet surface abuts against the first fillet surface.

8. The sealing ring assembly structure as described in claim 1, wherein the adhesive layer is double-sided adhesive.

9. The sealing ring assembly structure as described in claim 1, wherein the assembly body comprises a plurality of limiting convex rings, each of the limiting convex rings and the main body jointly enclose to form one limiting groove, the main body is provided with a plurality of first through holes, and the first through holes and the limiting grooves are arranged in one-to- one correspondence; and
wherein the sealing ring assembly structure comprises a plurality of sealing rings, and the sealing rings and the limiting grooves are arranged in one-to-one correspondence.

10. An electronic device, comprising the sealing ring assembly structure as described in claim 1.
